(19) United States
(12) Patent Application Publication
(10) Pub. No.: US 2026/0234429 A1
(43) Pub. Date: Aug. 13, 2026

(54) Method of Ink Jet Recording

(71) Applicant: Agfa NV, Mortsel (BE)

(72) Inventors: Bingyu Yang, Mortsel (BE); Jens Lenaerts, Mortsel (BE)

(73) Assignee: Agfa NV, Mortsel (BE)

(21) Appl. No.: 19/148,041

(22) PCT Filed: Jan. 8, 2024
(86) PCT No.: PCT/EP2024/050279

§ 371 Date: Jul. 15, 2025

(30) Foreign Application Priority Data
Jan. 16, 2023 (EP) 23151670.9

(51) Int. Cl. C09D 11/40; B41M 1/04; B41M 1/36; B41M 3/00; B41M 5/00; B41M 7/00; C09D 11/322; C09D 11/38; C09D 11/54

(52) U.S. Cl. CPC C09D 11/40; B41M 1/04; B41M 1/36; B41M 3/008; B41M 5/0017; B41M 5/0047; B41M 7/0036; B41M 7/009; C09D 11/322; C09D 11/38; C09D 11/54

(57) ABSTRACT

A recording method of inkjet printing aqueous inkjet inks on absorbing medium, the method comprising following steps: a) transporting the absorbing medium in a conveying direction, the medium having a width transversally oriented to the conveying direction; and b) adhering a pre-treatment liquid at least partially over the width of the absorbing medium to form a layer having a thickness from 1 to 5 μm, the pre-treatment liquid comprising water, a fixing agent, a hydrophilic binder selected from the group consisting of polyvinyl alcohol (PVOH) or modified polyvinylalcohol, water dispersible ethylene vinyl alcohol (EVOH), polysaccharides, including cellulose, cellulose derivatives, CMC, starch and starch derivatives and combinations of two or more thereof, the pre-treatment liquid has a viscosity from 40 to 300 mPa·s; and c) applying an aqueous inkjet ink to the layer to form an image by ejecting the ink from an inkjet head, the ink comprising a pigment, a water soluble organic solvent; and d) drying the layer and the applied inkjet ink by applying heat and airflow to the image.

### TECHNICAL FIELD

The invention relates to a recording method for inkjet printing aqueous inkjet inks on liners for corrugated packaging, folding boards and corrugated card boards.

### BACKGROUND ART

Inkjet printing is a growing area of printing of liners for corrugated packaging and of corrugated card boards. Preferably inkjet printing is performed by means of aqueous inkjet inks. Aqueous inkjet inks are inherently safer than reactive UV inks and inks whose primary vehicle is a solvent.

Both dyes and pigments have been used as colorants for aqueous inkjet inks and both have certain advantages. Pigment and disperse dye inks are advantageous because they tend to provide more water-fast and light-fast images than soluble dye inks.

Because aqueous inks printed on a receiver dry primarily by evaporation of the water without too much penetration or absorption of the water into the liner or cardboard, a number of problems are encountered. One such problem is that the individual ink droplets slowly spread laterally across the surface of the coating, leading to white lines in solid colour areas and to uneven patterns in solid colour areas due to touching and coalescing with adjacent ink droplets. This gives rise to a visual image quality artefact known as “coalescence” or “puddling.” Another problem encountered when inks dry too slowly and when two different colour inks are printed next to each other, the two colours tend to bleed into one another, resulting in a defect known as “inter-color bleed.” Yet another problem is that when printing at high speed, either in a sheet fed printing process, or in a roll-to-roll printing process, the printed image is not dried sufficiently before it comes in contact with an unprinted surface, and ink is transferred from the printed area to the unprinted surface, resulting in unwanted “ink retransfer”.

In order to obtain high quality images, pre-treatment fluids can be used to prime or pre-treat media before ink colorants are jetted onto the media to provide bleed and coalescence control as well as improve adherence and durability. The composition of a pre-treatment liquid is capable of receiving ink and holding or fixing colorants in the ink to a greater degree than a substrate not treated with a pre-treatment liquid. In particular, the composition of a pre-treatment liquid is capable of holding colorants at or near the surface of a substrate so that optical density and colour gamut of the printed image may be improved compared to an absorbing substrate that is not treated with the pre-treatment fluid.

However, if the pre-treatment liquid is applied onto the surface of a porous or absorbing recoding medium, it can penetrate into an absorbing recording medium or at least partially dry. When an aqueous pigment ink is provided onto that pre-treated recording medium, the reaction liquid is then present in the inside of the recording medium and not on the surface thereof. Consequently, almost all fixing reactions of colours occur in the inside of the recording medium. This results in problems of insufficient colour development leading to low colour densities.

EP 1 555137 A1 discloses a recording method in which a pre-treatment liquid containing a polyvalent metal salt is applied on a recording medium and then applying thereon a pigment ink within a time interval between 5 and 200 ms, having a lower surface tension than that of the above reaction liquid. Such short time intervals represent stringent conditions to printing equipment. The required limitations on surface tension values of ink and pre-treatment liquid represent severe limitations with respect to spreading and adhering of the pre-treatment liquid and reliable jetting of the inks.

WO14051547A discloses a method of wet-on-wet printing comprising the steps of applying an analog pre-treatment fluid to a low or non-absorbing media, digitally inkjet printing a first inkjet ink on the coated media sheet while the pre-treatment fluid is still wet, and digitally inkjet printing a second inkjet ink on the first inkjet ink while the analog pre-treatment fluid and the first inkjet ink are still wet. The analog pre-treatment liquid comprises latex as binder together with an associative thickener.

US 2013/0156953 discloses a pre-treatment fluid for low or non-porous printing media with a pigment ink composition including a liquid vehicle, a latex selected from the group consisting of acrylic polymers, acrylic copolymers, polyurethanes and an associative thickener. The pre-treatment fluid has a viscosity of about 10 cps to about 1000 cps and a surface tension of about 16 dynes/cm to about 30 dyne s/cm

Latex based binders in the pre-treatment liquids have the disadvantage that they lead to film formation of the liquid at the air/liquid interface blocking nozzles and tubes. This requires specific precautions in liquid supply and liquid application equipment in the printer. Besides the disadvantage of film formation, latex binders require an associative thickener to achieve the required viscosity of the pre-treatment liquid, are expensive compounds and further require mostly an organic solvent to promote film formation such as dipropylene glycol dimethyl ether or dipropylene glycol methyl ether. Organic solvents should be avoided to minimise toxic vapours being released during the drying of the pre-treatment liquid in the image formation.

There is still a need for a recording method including the application of a pre-treatment liquid onto absorbing media leading to acceptable image quality of the inkjet printed images in a wet-on-wet printing mode and not containing a latex or associative binder in the pre-treatment liquid.

### SUMMARY OF INVENTION

It is the objective of the present invention to provide a solution to the above stated problems. The objective has been achieved by providing a recording method adhering a pre-treatment liquid as a layer having a thickness of 1 μm to 5 μm, the liquid comprising a fixing agent, a hydrophilic binder, a cross-linking agent and a viscosity from 40 to 300 mPa·s and applying an aqueous inkjet ink to the layer as defined in claim 1.

It is another embodiment of the invention to provide a liquid set containing an aqueous inkjet ink and a pre-treatment liquid of claim 1 as defined in claim 12.

Other features, elements, steps, characteristics and advantages of the present invention will become more apparent from the following detailed description of preferred embodiments of the present invention. Specific embodiments of the invention are also defined in the dependent claims.

### BRIEF DESCRIPTION OF THE FIGURES

FIG. 1.: Pattern used for inkjet printing during the evaluation of the image quality and physical properties of images obtained with pre-treatment liquids. The pattern contains solid areas and negative text with different size ranging from 1 pt to 16 pt.

### DESCRIPTION OF EMBODIMENTS

### A. Recording Method for Inkjet Printing and Liquids Used Therein

### A.1. Recording Method for Inkjet Printing

The recording method of the invention for inkjet printing aqueous inkjet inks on absorbing media, comprises following steps:

First, transporting an absorbing medium in a conveying direction. The medium can have the shape of a sheet or a web. The medium has a width which is transversally oriented to the conveying direction.

Secondly adhering a pre-treatment liquid at least partially over the width of the recording medium to form a layer having a thickness from 1 to 5 μm, the pre-treatment liquid has a viscosity from 40 to 300 mPa·s at a shear rate of 1000 s⁻¹ at a temperature of 25° C.

The method employed to accomplish the adhering can be selected from a number of known techniques, including but not limited to spraying, rod coating, roll coating, blade coating, bar coating, gravure coating (direct, reverse, and offset), flexographic coating, size press (puddle and metered), and curtain coating.

Flexographic coating including the adhering of the pre-treatment liquid by means of an Anilox roller is preferred.

The flexographic coating technique with a Anilox roller is very suitable to apply homogenously pre-treatment liquids having a viscosity from 40 to 300 mPa·s at a wet layer thickness from 1 μm to 5 μm, preferably from 1.5 μm to 4 μm. If the layer thickness is below these ranges, insufficient fixing of the pigments of the inks will be achieved, leading to insufficient image quality. If the layer thickness is above the mentioned ranges, the applied amount of liquid such as water, is too high and will result in insufficient drying, especially at high printing speeds achievable with fixed arrays inkjet heads (so called single pass printing mode).

After coating the pre-treatment liquid on the media and while the pre-treatment liquid is still wet, having preferably a layer thickness from 0.5 μm to 5 μm, an aqueous pigment ink composition is applied on the wet pre-treatment liquid coated media.

A preferred method of applying the aqueous inkjet ink is by means of an ink jetting technique.

A preferred ink jet head for the jetting of the aqueous inkjet ink printing system is a piezoelectric ink jet head. Piezoelectric inkjet jetting is based on the movement of a piezoelectric ceramic transducer when a voltage is applied thereto. The application of a voltage changes the shape of the piezoelectric ceramic transducer in the print head creating a void, which is then filled with aqueous inkjet ink. When the voltage is again removed, the ceramic expands to its original shape, ejecting a drop of aqueous inkjet ink from the ink jet head. However, the jetting of the aqueous inkjet ink according to the present invention is not restricted to piezoelectric inkjet printing. Other inkjet print heads can be used and include various types, such as a continuous type, a thermal print head type, a Memjet-type of head and a valve jet type.

The inkjet head can be a fixed array of nozzles oriented transversally to the conveying direction, preferable over the width of the medium or can be incorporated in a scanning equipment which moves the inkjet head in a direction transversally to the conveying direction. Such a fixed array of nozzles oriented transversally to the conveying direction has the advantage that high productions speeds of printed images by inkjet can be obtained.

Specifically, for reliable jetting of metal oxide based white inks, the inkjet printing system includes preferably shaking, mixing or stirring equipment. This equipment is to re-disperse the white inkjet ink which may have settled in between print jobs. In some examples, the printing system may be configured to shake the cartridge, ink tank or ink buffer tank including the white inkjet ink. In other examples, the print cartridge or ink tank be configured to mix or stir the white inkjet prior to printing.

In a preferred embodiment, the printing system may be configured to recirculate the aqueous ink prior to printing. A particularly useful inkjet head to print the aqueous inkjet inks of the invention, is from the type that includes a recirculation of the ink within the head such as through-flow heads as disclosed in WO 2006/030235 A2 and WO 2006/064036 A1

This type of inkjet head is very suitable to be incorporated in a printing system comprising a through-flow print head having one or more nozzle for ejecting drops of aqueous ink onto a pre-treatment liquid layer, and an ink circulation system for feeding and circulating the ink through the print head, comprising an ink tank for containing the ink, a supply buffer tank for receiving the ink from the main tank and supplying the ink to the through-flow print head, a return manifold for receiving the ink from the through-flow print head and returning ink to the main ink tank via a pump.

The interval time between adhering the pre-treatment liquid and the application of the aqueous pigment ink is preferably between 200 ms and 30 s. Longer time intervals are less preferred as the pre-treatment liquid may then penetrate too much into the absorbing medium. Shorter time intervals are very difficult to achieve when high printing speed is used for the recording method of the invention, because the inkjet head must then be mounted very close to the coating or printing station for adhering the pre-treatment liquid to the recording medium.

After having applied the aqueous inkjet ink onto the layer of the pre-treatment liquid such that an image is formed, the image is dried.

The drying step of the image can be performed by applying an air flow and or apply heating. The heating step must be performed by using heat sources; examples include equipment for forced-air heating, radiation heating such as IR-radiation, including NIR-, CIR- and SWIR radiation, conduction heating, high-frequency drying, and microwave drying. Examples of the heating process include, but are not limited to, heat press, atmospheric steaming, high-pressure steaming, and THERMOFIX. Any heat source can be used for the heating process; for example, an infrared ray lamp is employed.

In order to further increase dry and wet rub resistance of the ink jetted image, a varnish can be applied onto the formed image. Preferably, the varnish is an aqueous solution or dispersion of a resin. The varnish is preferably applied via a jetting technique which allows to apply the varnish selectively onto the image or via a coating or printing technique. The advantage of the coating or printing technique is that thick varnish layers in one pass of the recording medium can be obtained to assure sufficient rub resistance of the image and additional protection of the non-image areas.

### A.2. Pre-Treatment Liquid

### A.2.1. Vehicle

The aqueous pre-treatment composition according to the invention comprises water as a vehicle. The aqueous vehicle may include one or more water-soluble organic solvents.

The one or more organic solvents may be added for a variety of reasons. For example, it can be advantageous to add a small amount of an organic solvent to improve the dissolution of a compound in the pre-treatment composition to be prepared.

Suitable water-soluble organic solvents are listed in § A.3.

### A.2.2. Binder

The pre-coating composition used in the invention further includes a hydrophilic polymer binder. The hydrophilic binder helps anchoring the pigments from the ink to the substrate and helps achieving the required viscosity of the pre-treatment liquid such as to obtain a uniform layer on the absorbing medium, especially if the pre-treatment liquid is to be applied by a flexographic technique.

Such hydrophilic polymer binder comprises a polymer capable of adsorbing water, and preferably is capable of forming a continuous phase solution. Non-exclusive examples of such materials include gelatin, hydroxycelluloses, polyvinyl alcohol, modified polyvinyl alcohol, water dispersible ethylene vinyl alcohol (EVOH), polysaccharides, including cellulose, cellulose derivatives, carboxymethyl cellulose (CMC), starch, starch derivatives, acrylic-based (co-)polymers, polyvinyl pyrrolidone, polyethylene imine, polyvinyl amine, and derivatives of these materials, and combinations of two or more of any of these compounds.

The hydrophilic polymer binder comprises preferably a polymer having hydroxyl-functional groups such as polyvinyl alcohols and more specifically polyvinyl alcohols having a saponification degree of 88%, more preferably 98% and more. Interaction taking place between the hydroxyl groups of the hydrophilic binder and the fixing agent which is a cationic compound leads to the formation a complex-like structure. This structure can result in enhanced wet film strength of the pre-treatment layer and the ink printed on top of it. According to a preferred embodiment of the invention, the binder is Poval 20 98 from Kuraray, a polyvinyl alcohol having a saponification degree of 98.0 to 98.8 mol %.

The pre-treatment liquid of the invention includes a hydrophilic polymeric binder in an amount from 5 to 70 wt. %, preferably from 8 to 60 wt. %, more preferably 15 to 45 wt. %, based on the weight of all dry components of the pre-treatment liquid composition.

More preferably the pre-treatment liquid of the invention includes a polyvinyl alcohol in an amount from 5 to 70 wt. %, more preferably from 8 to 50 wt. %, most preferably from 15 to 45 wt. % based on the weight of all dry components of the pre-treatment liquid composition. The polyvinyl alcohol in the pre-treatment of the invention has preferably a weight average molecular weight from about 50000 to about 250000 g/mol, the weight average molecular weight being measured with GPC and PE as reference. If the amount of polyvinyl alcohol and molecular weight is outside the above ranges, viscosity values of the pre-treatment liquid are obtained which are outside the preferred range of 40 mPa·s to 300 mPa·s

The hydrophilic polymeric binder in the pre-coating formulation used in the invention may be cross-linked to improve the jetted image resistance to abrasion while wet, as well as to provide increased cohesiveness of the coated layer upon drying.

Non-exclusive examples of cross-linking agents are dialdehydes such as glyoxal, Cartabond TSI (Clariant), Cartabond EPI (Clariant), Sequarez 755 (Omnova), glutaraldehyde sodium bisulfate complex (Aldrich), Sunrez 5 700M (Omnova), Sunrez 7000 (Omnova), CR-5L (Esprix), bis(vinyl) sulfone, bis(vinyl) sulfone methyl ether, adipoyl dihydrazide, boric acid, epichlorohydrin polyamide resins, carbodiimides, and urea-formaldehyde resins.

Preferably the cross-linking agent is boric acid, borax, sodium tetraborate, phenyl boronic acid, butyl boronic acid and combinations thereof. Without being bound by any specific theory, it is believed that these boron-containing compounds function as colorant fixatives that can chemically, physically, and/or electrostatically bind the pigments in the inkjet ink at the surface of the absorbing medium or the hydrophilic binder.

The viscosity of the pre-treatment fluid should be such that the pre-treatment fluid is well suited to be adhered on the absorbing media by preferably a coating or printing technique. Especially, for the adhering via flexographic printing, the pre-treatment preferably has a viscosity ranging from 40 to 300 mPa·s at a shear rate of 1000 s⁻¹ at 25° C., more preferably from 80 to 300 mPa·s at a shear rate of 1000 s⁻¹ at 25° C., most preferably from 90 to 300 mPa·s at a shear rate of 1000 s⁻¹ at 25° C. If the viscosity of the pre-treatment liquid is lower than this range, fast penetration into the absorbing media occurs and a limited interaction occurs between the fixing agent and the pigment of the ink printed on top of the pre-treatment liquid resulting in an inferior image quality. Viscosities above 300 mPa·s, can be obtained with the help of viscosity enhancers. However, viscosity enhancers do not have the beneficial interaction to form a complex-like structure taking place between the hydroxyl groups of a hydrophilic binder and the fixing agent which is a cationic compound. This structure can result in enhanced wet film strength of the pre-treatment layer and the ink printed on top of it.

Viscosities above 300 mPa·s increase further the risk of heterogeneity in the pre-treatment layer when applied at low wet layer thickness.

### A.2.3. Wax

The pre-treatment composition according to the invention may comprise a wax. The wax may improve the durability of the ink and pre-treatment package during general handling. Generally, any suitable wax may be used in the pre-treatment composition. As such, the wax may be polyethylene waxes, petroleum waxes, paraffin waxes, carnauba waxes, polypropylene waxes, crystalline and microcrystalline waxes, amide waxes (oleamide, stearamide, erucamide, cyclic amide, etc. . . . ), and combinations thereof. In an aspect of the invention, the wax may be a high density polyethylene wax.

In an aspect of the invention, the wax may be a polyethylene wax or modified paraffin wax. An example of polyethylene wax includes high density polyethylene (HDPE) wax, which has a density ranging from about 0.93 g/mL to 0.97 g/mL. The density of HDPE is generally higher than the density of low density polyethylene (LDPE) due, at least in part, to a smaller amount of molecular branching in HDPE.

An example of modified paraffin wax particles includes paraffin wax that has been modified to improve dispersability in water, e.g., via emulsification. The modified paraffin wax may be surface modified, chemically modified, etc.

Some specific examples of wax that may be used include those of the JONCRYL Wax series (such as JONCRYL Wax 22, JONCRYL Wax 26, and JONCRYL Wax 120 available from BASF Corp.), those of the AQUACER series (such as AQUACER 498, AQUACER 501, AQUACER 505, AQUACER 513, AQUACER 530, AQUACER 531, AQUACER 535, AQUACER 537, AQUACER 539, and AQUACER 552 available from BYK-Gardner, Columbia, Md.) and Liquilube 404E from Lubrizol. The wax may also or otherwise be chosen from water-dispersed wax available from Micro Powders, Inc., Tarrytown, N. Y.

The wax may have i) a high melting temperature T and/or ii) a small average particle size. In an example, the wax may have a high melting T such as one that is equal to or greater than about 100° C. In an example, the T of the wax may range from about 100° C. to about 150° C. In another example, the T of the wax may range from about 110° C. to about 135° C. Further, the wax may have an average particle size (in terms of effective diameter assuming that the individual wax particles are not perfectly spherical) ranging from 0.03 μm to 1.5 μm, more preferably from 0.05 μm to 1 μm, most preferably from 0.07 μm to 0.50 μm (D50). The particle size of the wax may be measured by various techniques, such as dynamic light scattering. If the particle size exceeds these upper limits, jetting reliability problems of the pre-coat composition are likely to occur.

The wax may be present in the pre-treatment liquid in an amount ranging from 3 to 25 wt. %, more preferably from 5 to 20 wt. %, relative to the total solids weight of the pre-treatment composition.

### A.2.4. Fixing Agent

The fixing agent present in the pre-treatment composition is preferably a multivalent metal salt or a cationic polymer which is able to react with the anionic compound in the inkjet ink, being an anionic charged pigment.

The polyvalent metal salt may be present in the pre-treatment composition to improve inkjet print quality. Generally, the polyvalent metal salt may be any water-soluble polyvalent metal salt. In specific examples, the polyvalent metal salt may include calcium chloride (CaCl₂), magnesium chloride (MgCl₂), magnesium sulfate (MgSO₄), aluminium chloride (AlCl₃), calcium nitrate (Ca(NO₃)₂), magnesium nitrate (Mg(NO₃)₂), magnesium acetate (Mg(CH₃COO)₂), zinc acetate (Zn(CH₃COO)₂) calcium propionate (Ca(C₂H₅COO)₂), or a combination thereof. In further examples, the polyvalent metal salt may include a metal cation selected from calcium, copper, nickel, magnesium, zinc, barium, iron, aluminium, chromium, or another polyvalent metal.

The polyvalent metal salt may also include an anion. In some examples, the anion may be fluoride, chloride, iodide, bromide, nitrate, chlorate, sulfate, acetate, or RCOO⁻ where R is hydrogen or any low molecular weight hydrocarbon chain, e.g., C1 to C12. In a more specific example, the anion may be a carboxylate derived from a saturated aliphatic monocarboxylic acid having 1 to 6 carbon atoms or a carbocyclic monocarboxylic acid having 7 to 11 carbon atoms. Examples of saturated aliphatic monocarboxylic acid having 1 to 6 carbon atoms may include formic acid, acetic acid, propionic acid, butyric acid, isobutyric acid, valeric acid, isovaleric acid, pivalic acid, and/or hexanoic acid. The cationic salt may also be a mixture of two or more different cationic salts.

In some cases, the polyvalent metal salt may be present in an amount from 1 wt. % to 99 wt. % with respect to the entire weight of the pre-treatment composition. In more specific examples, the polyvalent metal salt may be present in an amount from 5 wt. % to 65 wt. %, more preferably from 25 wt. % to 60 wt. %, with respect to solids content of the pre-treatment composition. If the amounts are below the lower limits, insufficient fixing of the colorants occur resulting in a reduced image quality.

Polymeric cationic polymers, suitable as fixing agent in the pre-treatment composition contain either guanidinium or fully quaternized ammonium functionalities, such as quaternized polyamine copolymers. Typical Mw are less than 500.000, and in one aspect, less than 50.000.

Suitable classes of cationic polymers that can be used include, but are not limited to, quaternized polyamines, dicyandiamide polycations, diallyldimethyl ammonium chloride copolymers, quaternized dimethylaminoethyl(meth)acrylate polymers, quaternized vinylimidizol polymers, alkyl guanidine polymers, alkoxylated polyethylene imines, and mixtures thereof.

### A.3. Aqueous Inkjet Ink

The aqueous inkjet ink used in the recording method according to the invention and which is used to print upon the layer of the pre-treatment liquid layer, comprises a pigment. The aqueous medium of the ink contains water, but may include one or more water-soluble organic solvents.

In a preferred embodiment of the invention, the aqueous inkjet ink comprises a resin and or a wax. Suitable waxes are described in § A.2.3.

The aqueous inkjet ink may further comprise a surfactant, a humectant, a biocide, a resin, an anti-foam additive, an anti-corrosion additive and a thickener as an additive.

### A.3.1. Pigment

The pigments in the aqueous inkjet ink according to the invention may be black, white, cyan, magenta, yellow, red, orange, violet, blue, green, brown, mixtures thereof, and the like. A colour pigment may be chosen from those disclosed by HERBST, Willy, et al. Industrial Organic Pigments, Production, Properties, Applications. 3rd edition. Wiley—VCH, 2004. ISBN 3527305769.

Suitable pigments are disclosed in paragraphs [0128] to [0138] of WO 2008/074548.

The pigment particles are dispersed in an aqueous medium using a polymeric dispersant, a surfactant or a combination thereof. Self-dispersible pigments can also be used. The latter prevents interaction of the polymeric dispersant with the dispersing groups of resin particles or capsules which may be included in the inkjet ink (see below).

A self-dispersible pigment is a pigment having on its surface covalently bonded anionic hydrophilic groups or salt-forming groups, that allow the pigment to be dispersed in an aqueous medium without using a surfactant or a resin.

The technology for making self-dispersible pigments is well-known. For example, EP1220879A discloses pigments having attached a) at least one steric group and b) at least one organic ionic group and at least one amphiphilic counterion, wherein the amphiphilic counterion has a charge opposite to that of the organic ionic group that are suitable for inkjet inks. Also EP906371A discloses suitable surface-modified coloured pigment having attached hydrophilic organic groups containing one or more ionic groups or ionizable groups. Suitable commercially available self-dispersible colour pigments are, for example, the CAB-O-JET™ inkjet colorants from CABOT.

Pigment particles in inkjet inks should be sufficiently small to permit free flow of the ink through the inkjet-printing device, especially at the ejecting nozzles. It is also desirable to use small particles for maximum colour strength and to slow down sedimentation.

The average pigment particle size is preferably between 0.050 and 1 μm, more preferably between 0.070 and 0.300 μm and particularly preferably between 0.080 and 0.200 μm. Most preferably, the numeric average pigment particle size is no larger than 0.150 μm. The average particle size of pigment particles is determined with a Brookhaven Instruments Particle Sizer BI90plus based upon the principle of dynamic light scattering.

Suitable white pigments are given by Table 2 in [0116] of WO 2008/074548. The white pigment is preferably a pigment with a refractive index greater than 1.60. The white pigments may be employed singly or in combination. Preferably titanium dioxide is used as pigment with a refractive index greater than 1.60. Suitable titanium dioxide pigments are those disclosed in [0117] and in [0118] of WO 2008/074548.

Also special colorants may be used, such as fluorescent pigments for special effects in clothing, and metallic pigments for printing a luxury look of silver and gold colours on textiles.

Suitable polymeric dispersants are copolymers of two monomers but they may contain three, four, five or even more monomers. The properties of polymeric dispersants depend on both the nature of the monomers and their distribution in the polymer. Co-polymeric dispersants preferably have the following polymer compositions:
statistically polymerized monomers (e.g. monomers A and B polymerized into ABBAABAB);
alternating polymerized monomers (e.g. monomers A and B polymerized into ABABABAB);
gradient (tapered) polymerized monomers (e.g. monomers A and B polymerized into AAABAABBABBB);
block copolymers (e.g. monomers A and B polymerized into AAAAABBBBBB) wherein the block length of each of the blocks (2, 3, 4, 5 or even more) is important for the dispersion capability of the polymeric dispersant;
graft copolymers (graft copolymers consist of a polymeric backbone with polymeric side chains attached to the backbone); and
mixed forms of these polymers, e.g. blocky gradient copolymers.

Suitable dispersants are DISPERBYK™ dispersants available from BYK CHEMIE, JONCRYL™ dispersants available from BASF and SOLSPERSE™ dispersants available from Lubrizol. A detailed list of non-polymeric as well as some polymeric dispersants is disclosed by MC CUTCHEON. Functional Materials, North American Edition. Glen Rock, N.J.: Manufacturing Confectioner Publishing Co., 1990. p. 110-129.

The polymeric dispersant has preferably a number average molecular weight Mn between 500 and 30000, more preferably between 1500 and 10000.

The polymeric dispersant has preferably a weight average molecular weight Mw smaller than 100,000, more preferably smaller than 50,000 and most preferably smaller than 30,000.

The pigments are preferably present in the range of 0.01 to 15%, more preferably in the range of 0.05 to 10% by weight and most preferably in the range of 0.1 to 5% by weight, each based on the total weight of the inkjet ink. For white inkjet inks, the white pigment is preferably present in an amount of 3% to 40% by weight of the inkjet ink, and more preferably 5% to 35%. An amount of less than 3% by weight cannot achieve sufficient covering power.

In a preferred embodiment of the invention the aqueous ink comprises a pigment which is encapsulated by means of a cross-linked polymeric shell. Encapsulated pigments provide higher stability certainly in formulations in which pigment dispersions and resin dispersions are mixed.

Suitable encapsulated pigments are provided by Lubrizol as Diamond HSDX-dispersions and by Fujifilm as RxD pigment dispersions such as APD1000 and APD400 premium dispersions.

### A.3.2. Vehicle

The aqueous ink according to the invention comprises water as a vehicle. The aqueous vehicle may further include one or more water-soluble organic solvents.

The one or more organic solvents may be added for a variety of reasons. For example, it can be advantageous to add a small amount of an organic solvent to improve the dissolution of a compound in the ink composition to be prepared or to prevent fast drying of the ink at the nozzle of the inkjet head. Preferable water-soluble organic solvents are polyols (e.g., ethylene glycol, glycerin, 2-ethyl-2-(hydroxymethyl)-1,3-propanediol, tetraethylene glycol, triethylene glycol, tripropylene glycol, 1,2,4-butanetriol, diethylene glycol, propylene glycol, dipropylene glycol, butyleneglycol, 1,6-hexanediol, 1,2-hexanediol, 1,5-pentanediol, 1,2-propane diol, 1,3-propane diol, 1,2-pentanediol, 2,2-dimethyl-1,3-propanediol, 2-methyl-2,4-pentanediol, 3-methyl-1,5-pentanediol, 3-methyl-1,3-butanediol, and 2-methyl-1,3-propanediol), N-hydroxyethyl-pyrrolidon, N-butyl-pyrrolidon, amines (e.g., ethanolamine, and 2-(dimethylamino)ethanol), monohydric alcohols (e.g., methanol, ethanol, and n-butanol), alkyl ethers of polyhydric alcohols (e.g., diethylene glycol monomethyl ether, diethylene glycol monobutyl ether, triethylene glycol monomethyl ether, triethylene glycol monobutyl ether, ethylene glycol monomethyl ether, ethylene glycol monobutyl ether, propylene glycol monomethyl ether, propylene glycol monobutyl ether, and dipropylene glycol monomethyl ether), 2,2′-thiodiethanol, amides such as N,N-dimethylformamide, heterocycles such as 2-pyrrolidone and N-methyl-2-pyrrolidone, and acetonitrile.

Preferably, if two or more organic solvents are present in the ink, one of the organic solvents has a boiling point of 150° C. or more and 250° C. or less. If the boiling point is below this range, the solvent is very volatile and may give an unwanted odour to the ink. When the boiling point of the solvent is above the mentioned range, the solvents have the tendency of not being eliminated in the drying step and remain in the printed image leading to a reduced resistance to rubbing and scratching of the printed image. This water soluble organic solvent is preferably added to the ink composition formulation in an amount of 0.1 to 55 wt. % based on the total weight of the ink.

### A.3.3. Resin

The ink jet ink composition according to the invention may comprise a resin suspension. The resin is often added to the ink jet ink formulation to achieve a good adhesion of the pigment to the recording medium. The resin is preferably a polymer and suitable resins can be an acrylic based resin, a urethane resin or a wax.

The polyurethane resin is to be incorporated in the ink formulation as a dispersion and may be selected from the group consisting of aliphatic polyurethane dispersions, aromatic polyurethane dispersions, anionic polyurethane dispersions, non-ionic polyurethane dispersions, aliphatic polyester polyurethane dispersions, aliphatic polycarbonate polyurethane dispersions, aliphatic acrylic modified polyurethane dispersions, aromatic polyester polyurethane dispersions, aromatic polycarbonate polyurethane dispersions, aromatic acrylic modified polyurethane dispersions, for example, or a combination of two or more of the above.

A preferred urethane resin to be used as dispersion in the ink of the invention is a polyester resin including a structural unit containing a urethane bond. Among such resins, a water-soluble or water-dispersible urethane-modified polyester resin is preferred. It is preferable that the urethane-modified polyester resin include at least one structural unit derived from a hydroxyl group-containing polyester resin (polyester polyol) and at least one structural unit derived from an organic polyisocyanate.

Furthermore, the hydroxyl group-containing polyester resin is a resin formed by an esterification reaction or transesterification reaction between at least one polybasic acid component and at least one polyhydric alcohol component.

A preferred polyurethane resin to be included in the ink of the invention is a polyurethane resin obtainable by reacting a polyester polyol, a polyether diol, a polyol containing an anionic group and a polyisocyanate. Examples of suitable polyurethane resins and their preparations are disclosed in the unpublished patent application EP16196224.6.

Some examples of suitable polyurethane dispersions are NEOREZ R-989, NEOREZ R-2005, and NEOREZ R-4000 (DSM NeoResins); BAYHYDROL UH 2606, BAYHYDROL UH XP 2719, BAYHYDROL UH XP 2648, and BAYHYDROL UA XP 2631 (Bayer Material Science); DAOTAN VTW 1262/35WA, DAOTAN VTW 1265/36WA, DAOTAN VTW 1267/36WA, DAOTAN VTW 6421/42WA, DAOTAN VTW 6462/36WA (Cytec Engineered Materials Inc., Anaheim CA); and SANCURE 2715, SANCURE 20041, SANCURE 2725 (Lubrizol Corporation), for example, or a combination of two or more of the above.

Acrylic based resins include polymers of acrylic monomers, polymers of methacrylic monomers, and copolymers of the aforementioned monomers with other monomers. These resins are present as a suspension of particles having an average diameter of about 30 nm to about 300 nm. The acrylic latex polymer is formed from acrylic monomers or methacrylic monomer residues. Examples of monomers of the acrylic latex polymer include, by way of illustration, acrylic monomers, such as, for example, acrylate esters, acrylamides, and acrylic acids, and methacrylic monomers, such as, for example, methacrylate esters, methacrylamides, and methacrylic acids. The acrylic latex polymer may be a homopolymer or copolymer of an acrylic monomer and another monomer such as, for example, a vinyl aromatic monomer including, but not limited to, styrene, styrene butadiene, p-chloromethylstyrene, divinyl benzene, vinyl naphthalene and divinylnaphthalene.

Some examples of suitable acrylic latex polymer suspensions are, JONCRYL 537 and JONCRYL 538 (BASF Corporation, Port ArthurTX); CARBOSET GA-2111, CARBOSET CR-728, CARBOSET CR-785, CARBOSET CR-761, CARBOSET CR-763, CARBOSET CR-765, CARBOSET CR-715, and CARBOSET GA-4028 (Lubrizol Corporation); NEOCRYL A-1110, NEOCRYL A-1131, NEOCRYL A-2091, NEOCRYL A-1127, NEOCRYL XK-96, and NEOCRYL XK-14 (DSM); and BAYHYDROL AH XP 2754, BAYHYDROL AH XP 2741, BAYHYDROL A 2427, and BAYHYDROL A2651 (Bayer), for example, or a combination of two or more of the above.

The aqueous inkjet ink of the invention may also comprise a wax. The wax in the ink improves wet rub or wet scratch resistance of the printed layer.

The ink jet ink composition according to the invention may comprise a capsule. Capsules, more preferably, nanocapsules are often incorporated in ink jet ink formulations to encapsulate colouring agents (US2009227711A, JP2004075759) or to encapsulate reactive ingredients which can cross-link. Particularly useful are the nanocapsules disclosed in WO2015158649 [0037-0110]: The nanocapsules have a polymeric shell surrounding a core containing reactive chemistry. The shell material includes polyureas, polyurethanes, polyesters, polycarbonates, polyamides, melamine based polymers and mixtures thereof, with polyureas and polyurethanes being especially preferred. Other particularly useful nanocapsules are disclosed in WO2016165970 [0051-0138]: the nanocapsules are selfdispersable and include a dispersing group covalently coupled to the shell polymers. The core of the nanocapsules in WO2015158649 [0037-0110] and WO2016165970 [0051-0138] comprise reactive chemistry which is able to form a reaction product upon application of heat and/or light, allowing a wide variety of substrates to be addressed. Other suitable reactive chemistry is the one which is activated upon radiation as described in WO2015158649 [0068-0110].

The resins are preferably present in the inkjet ink in an amount of no more than 30 wt. %, preferably between 0.3 and 25 wt. % based on the total weight of the ink.

### A.3.4. Additives

The ink composition may contain a surfactant. Any known surfactant may be used but preferably a glycol surfactant and/or an acetylene alcohol surfactant and/or a polysiloxane surfactant is to be used. The use of the acetylene glycol surfactant and/or the acetylene alcohol surfactant and/or the polysiloxane surfactant improves the drying property in printing to allow high-speed printing.

The acetylene glycol surfactant and/or the acetylene alcohol surfactant is preferably one or more selected from 2,4,7,9-tetramethyl-5-decine-4,7-diol, alkylene oxide adducts of 2,4,7,9-tetramethyl-5-decine-4,7-diol, 2,4-dimethyl-5-decin-4-ol, and alkylene oxide adducts of 2,4-dimethyl-5-decin-4-ol. These are available from Nissin Chemical Industry, for example, as Olfine (registered trademark) E series, such as Olfine E1010, or from Evonik (formerly Air Products (GB)) as Surfynol (registered trademark), 104, Surfynol 465 and Surfynol 61.

A biocide may be added to the ink composition to prevent unwanted microbial growth, which may occur over time. The biocide may be used either singly or in combination. Suitable biocides for the ink-jet ink of the present invention include sodium dehydroacetate, 2-phenoxyethanol, sodium benzoate, sodium pyridinethion-1-oxide, ethyl p-hydroxybenzoate and 1,2-benzisothiazolin-3-one and salts thereof.

Preferred biocides are Proxel™ GXL and Proxel™ Ultra 5 available from ARCH UK BIOCIDES and Bronidox™ available from COGNIS.

A biocide is preferably added to the aqueous medium in an amount of 0.001 to 3 wt. %, more preferably 0.01 to 1.0 wt. %, each based on the total weight of the liquid.

The ink composition may further comprise at least one thickener for viscosity regulation in the liquid. Suitable thickeners include urea or urea derivatives, hydroxyethylcellulose, carboxymethylcellulose, hydroxypropylcellulose, derived chitin, derived starch, carrageenan, pullulan, proteins, poly(styrenesulphonic acid), poly(styrene-co-maleic anhydride), poly(alkyl vinyl ether-co-maleic anhydride), polyacrylamid, partially hydrolyzed polyacrylamid, poly(acrylic acid), poly(vinyl alcohol), partially hydrolyzed poly(vinyl acetate), poly(hydroxyethyl acrylate), poly(methyl vinyl ether), polyvinylpyrrolidone, poly(2-vinylpyridine), poly(4-vinylpyridine) and poly(diallyldimethylammonium chloride).

The thickener is added preferably in an amount of 0.01 to 20 wt. %, more preferably 0.1 to 10 wt. % based on the liquid.

The ink composition may also contain an optothermal converting agent, which may be any suitable compound absorbing in the wavelength range of emission by an infrared light source. The optothermal converting agent is preferably an infrared dye as this allows easy handling into the liquid. Suitable examples of infrared dyes are disclosed in [0179] of WO2015158649.

The one or more optothermal converting agents are preferably present in the range of 0.1 to 10 wt. % based on the total weight of the liquid.

### A.4. Varnish

The varnish which can be used in the recording method according to the invention contains a resin. Examples of the resin included in the varnish include well-known resins such as a urethane-based resin, an acrylic resin, a fluorene-based resin, a polyolefin-based resin, a rosin modified resin, a terpene-based resin, a poly-ester-based resin, a polyamide-based resin, an epoxy-based resin, and a vinyl chloride-based resin. The vinyl chloride-based resin includes a vinyl chloride copolymer such as a vinyl chloride-vinyl acetate copolymer. These resins may be used alone, or two or more thereof may be used in combination with a crosslinker such as an epoxide or carbodiimide.

Among the aforementioned resins, the resin included in the varnish preferably is a urethane-based resin, an acrylic resin or a polyolefin-based resin

The acrylic resin is a general name of a polymer obtained by polymerizing at least an acrylic monomer such as (meth)acrylic acid and (meth)acrylate, and the examples thereof include a (meth)acryl resin obtained from the acrylic monomer, and a copolymer of the acrylic monomer and monomers other than the acrylic monomer (for example, a vinyl based monomer such as styrene). Acrylamide and acrylonitrile can be also used as the acrylic monomer. As a resin emulsion using the acrylic resin as a raw material, commercially available products may be used, and the examples thereof include Neocryl D2101 (Covestro Coating Resins BV) FK-854 (trade name, manufactured by CHIRIKA. Co., ltd.), Mowinyl 952B, 718A (trade name, manufactured by The Nippon Synthetic Chemical Industry Co., Ltd.), Nipol LX852, and LX874 (trade name, manufactured by ZEON Corporation).

As the urethane-based resin, commercially available products may be used, for example, commercially available products such as SUPER FLEX 460, 460s, 840, E-4000 (trade name, manufactured by DKS Co., Ltd.), RESAMINE D-1060, D-2020, D-4080, D-4200, D-6300, D-6455 (trade name, manufactured by Dainichiseika Color&Chemicals Mfg. Co., Ltd.), TAKELAC WS-6021, W-512-A-6 (trade name, manufactured by Mitsui Chemicals Polyurethanes INC.), SUNCURE 2710 (trade name, manufactured by LUBRIZOL Corporation), and PermalinUA-150 (trade name, manufactured by Sanyo Chemical Industries, Ltd.) may be used.

The polyolefin-based resin has olefin such as ethylene, propylene, and butylene as a structural skeleton, and the well-known resins may be appropriately selected to be used. As the olefin resin, commercially available products may be used, and the examples thereof include Arrowbase CB-1200 and CD-1200 (trade name, manufactured by UNITIKA LTD.).

The resin included in the varnish preferably includes a resin having a glass transition temperature (Tg) of 80° C. or lower, more preferably includes a resin having Tg of 40° C. to 80° C. When the first resin includes a resin having Tg of 80° C. or lower, adhesion of the varnish to the recording medium may become excellent, and when the first resin includes a resin having Tg of 40° C. or higher, it possible to suppress the tackiness of the clear ink attached on the recording medium.

The varnish contains the resin in an amount from 1 wt. % to 30 wt. % with respect to the total mass of the varnish. When the content of the resin in the varnish is within the aforementioned range, the effect of improving rub resistance of the image tends to become more excellent.

### A.5. Recording Medium

The recording medium used in the method of the invention is an absorbing medium. A medium is characterized as absorbing, when the amount of absorbed water after a contact time of 60 s is at least 10 g/m². Absorbing media are media which are porous or which comprise binders which are able to swell when brought in contact with an aqueous liquid.

Porous substrates include paper, card board, white lined chipboard, corrugated board, packaging board, folding board, wood, ceramics, stone, leather and textile. The pre-treatment composition of the invention is particularly suited for being adhered onto papers intended for packaging applications. The papers can be a single layer of a multilayer paper.

The paper may be brown Kraft, White Top or bleached board. The paper may be manufactured from chemical, wood, or recycled fibre. As an example, the paper may be a liner intended for printing on page wide web presses and converted into corrugated boxes. In this aspect, the liner paper may be used as a double face liner and may be converted directly in a corrugator or laminated onto a double face liner after corrugation. The paper may also be boards used for boxes and other packaging applications.

### B. Examples

### B.1. Materials

All materials used in the following examples were readily available from standard sources such as Aldrich Chemical Co. (Belgium) and Acros (Belgium) unless otherwise specified. Where used, water is demineralised water.
Poval 20 98 is a polyvinyl alcohol having a hydrolysis degree of 98% from KURARAY; the product is pre-dissolved in water before-hand in order to facilitate the preparation of pre-treatment liquid.
Poval 56 98 is a fully saponified grade of polyvinyl alcohol from Kuraray Europe GmbH; the product is pre-dissolved in water before-hand in order to facilitate the preparation of pre-treatment liquid.
Joncryl 538-A is a 45% styrene acrylic polymer dispersion in water from BASF SE.
Bayhydrol UH 2606 is a 35% aliphatic, anionic polyurethane dispersion in water from Covestro AG.
Liquilube 404E is a 35% emulsion of High Density Polyethylene (HDPE) wax in water from Lubrizol Corporation.
Rheolate 666 is a polyether urea polyurethane associative thickener with 20% active solids from Elementis plc.
DMM is dipropylene glycol dimethyl ether from Dow Chemicals
DPM is dipropylene glycol methyl ether from Dow Chemicals
Dynax DX 4000 is a fluorosurfactant from, Dynak Corporation, Pound Ridge, NY.
Byk 022 is a silicone defoamer from BYK USA Inc., Wallingford CT.
Mergal K9N is an in-can preservative for aqueous systems from Troy Chemical Company B.V.
Ultralube GA 1042 is a 35 wt. % HDPE wax dispersion from KEIM-ADDITEC SURFACE GMBH
Surfynol 104PG50 is a 50 wt. % solution of 2,4,7,9-Tetramethyl-5-decyne-4,7-diol in propylene glycol from Evonik
Kauropal K933 is a 100% non-ionic oxirane, mono(2-propylheptyl) ether from BASF
Tego Foamex 822 is a 20% defoaming agent containing an emulsion of a polyether siloxane copolymer in water from Evonik Industries AG.
Glyoxal 40 is a 40% solution of Glyoxal in water and is as such available at BASF
Edaplan is Edaplan™ 482, a polymeric dispersant from MUNZING.
Cyan pigment is a Pigment blue 15:3—FASTOGEN BLUE LA 5380 produced by Sun Chemical corporation
Proxel is a 5% aqueous solution of 1,2-benzisothiazolin-3-one available as Proxel™ K from Azelis Corporate Services NV
HSDCX1 is a 19.7 wt. % encapsulated Pigment Blue 15:3 dispersion in water from Lubrizol Corporation.
Mg(NO₃)₂·6H₂O is Magnesium nitrate hexahydrate from Merck Group
Boric acid is from Merck Group
D.I. Water is deionized water

### B.2. Evaluation Methods

### B.2.1. Sample Preparation

The pre-treatment liquids were adhered onto a coated corrugated liner XLHD MM X-Liner HD (180 g/m2) from MM Karton. Two adhering methods were evaluated: a bar coating method and a flexographic coating method. In the case of a bar coating method, the corrugated liner was coated using a 4 μm spiral bar, resulting in a layer thickness of 4 μm. In the case of coating with a flexographic coater, the corrugated liner was coated using a K Printing Proofer (RK Printcoat Instruments) equipped with a Flexo Head and a standard 200 lines per inch solid area plate, resulting in an applied layer thickness of approximately 1.5 μm.

After adhering the pre-treatment liquid, the pre-treated samples were printed without pre-drying, i.e. wet-in-wet printing. Taking the operation time such as transporting the samples onto the printer and start up the printing into consideration, the time interval between the pre-treatment adhering and the printing the image with an aqueous inkjet ink, was less than 30 seconds.

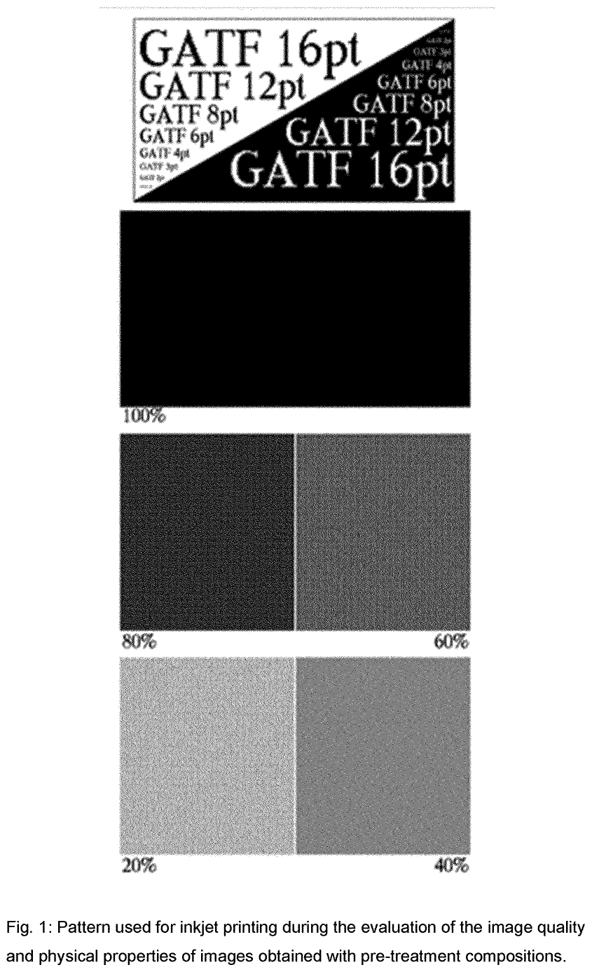

After adhering the pre-treatment liquids, the pre-treated liner samples were printed by means of an ImageXpert JetXpert with GIS print head driving electronics for FujiFilm Dimatix Samba print head (Samba G3L) with a drop volume between 5.4-6.5 pl at a voltage between 19.5-23.5 V at 32° C. and with a firing frequency of 7.8 kHz using an aqueous cyan ink. The printed images were dried at 60° C. for 2 minutes in an oven. The pattern of the printed image is shown in FIG. 1.

### B.2.2. Image Quality

The image quality of the printed images was evaluated by visually analysing the following three properties: 1) ink spreading; 2) ink fixing and 3) image sharpness.

Ink spreading: the ink should completely cover the solids in the printed image. A lack of ink spreading is demonstrated by the appearance of white lines in the solid areas. The evaluation was conducted by visually observing the solid areas and by giving a score from 0 (excellent ink spreading, complete coverage) to 3 (poor ink spreading, more than 20 white lines visible in the solid area).

Ink fixing: the ink should homogenously and intensely cover the solids in the printed image. A lack of ink fixing is demonstrated by the appearance of uneven patterns in the solid areas. The ink fixing was evaluated by visually observing the solid areas and by giving a score from 0 (excellent ink fixing, homogeneous coverage) to 3 (poor ink fixing, strong unevenness observable).

Image sharpness: the fine texts of should be readable. A lack of image sharpness is demonstrated by the disappearance of negative text. The image sharpness was evaluated by visually observing the negative texts and by giving a score from 0 (excellent image sharpness, 6 pt clearly readable) to 3 (poor image sharpness, 16 pt partially or totally covered by ink).

### B.2.3. Viscosity

The viscosity of the pre-treatment liquids was measured as follows. The dynamic viscosity of the pre-treatment liquids was measured using a Thermo Scientific HAAKE RotoVisco 1 viscometer. The dynamic viscosity of the pre-treatment liquid was measured at the temperature of 25° C. and with the shear rate of 1000 s⁻¹.

### B.3. Example 1

Example 1 shows that the recording method using a pre-treatment liquid according to the invention provides ink jetted images showing a higher image quality with respect to pre-treatment liquids based on a latex binder.

### B.3.1. Preparation of Pre-Treatment Liquids and Aqueous Pigment Inks

The pre-treatment liquid compositions were prepared by mixing the ingredients given in Table 1. The weight percentages are relative to the total weight of the pre-treatment liquid. The raw materials were used as supplied without any further treatments.

TABLE 1
Composition of pre-treatment liquids

| | COMP-PL1 | INV-PL1 |
|---|---|---|
| Poval 20 98 | — | 5.4 |
| Joncryl 538-A | 11.11 | — |
| Bayhydrol UH 2606 | 28.57 | — |
| Liquilube 404E | 11.43 | 4.0 |
| Rheolate 666 | 2.14 | — |
| DMM | 3.0 | — |
| DPM | 2.0 | — |
| Mg(NO₃)₂•6H₂O | — | 16.0 |
| Kauropal K933 | — | 0.04 |
| Dynax DX 4000 | 2.57 | — |
| Tego Foamex 822 | — | 0.04 |
| Byk 022 | 0.2 | — |
| Mergal K9N | — | 0.01 |
| Boric acid | — | 0.29 |
| D.I. Water | To complete | To complete |
| | to 100% | to 100% |
| Viscosity @ | 40.1 | 101.0 |
| 1000 s⁻¹ | | |

An aqueous cyan ink was prepared by diluting the wax dispersion with the other ink ingredients according to Table 2, the ingredients expressed in wt. % based on the total weight of the ink. Water was added to complete the ink to the desired pigment concentration.

TABLE 2
Composition of the aqueous inkjet ink INV-INK1

| | INV-INK1 |
|---|---|
| Ultralube GA 1042 | 1.43 |
| Propanediol | 42.0 |
| n-Butanol | 2.95 |
| Surfynol 104 PG50 | 0.4 |
| Proxel | 0.2 |
| HSDCX1 | 13.16 |
| D.I. Water | To complete |
| | to 100% |

### B.3.2. Results of Image Quality Evaluation

The pre-treatment liquids COMP-PL1 and INV-PL1 were adhered onto the coated corrugated liner as described in § B.2.1. The pre-treated samples were printed as described in § B.2.1. and the image quality of the obtained images was evaluated according § B.2.2.

In Table 3, the image quality results are listed of the printed images onto the comparative and inventive pre-treatment compositions.

TABLE 3
Image quality evaluation of printed images onto pre-treated liners

| Pre-treatment | |
|---|---|
| INV-PL1 | COMP-PL1 |

| Coating | Flexo- | Bar | Flexo- | Bar |
|---|---|---|---|---|
| method | graphic | coater | graphic | coater |
| Ink spreading | 0 | 1 | 3 | 2 |
| Ink fixing | 0 | 0 | 3 | 3 |
| Image sharpness | 0 | 0 | 0 | 0 |

From Table 3 it can be concluded that the recording method wherein a pre-treatment liquid comprising a hydrophilic binder is adhered as a layer having a thickness from 1 to 5 μm leads to inkjet printed images having an improved image quality with respect to the recording method using a pre-treatment liquid comprising a latex binder.

### B.4. Example 2

Example 2 shows that boric acid as cross-linker in the pre-treatment liquid leads to inkjet printed images with an improved image quality.

### B.4.1. Preparation of Pre-Treatment Liquids and Inkjet Ink

Three pre-treatment liquids were prepared by mixing the ingredients given in Table 4. The weight percentages are relative to the total weight of the pre-treatment liquids. The raw materials were used as supplied without any further treatments unless otherwise stated. Viscous translucent liquids were obtained after thorough mixing.

TABLE 4
Composition of inventive pre-treatment liquids

Pre-treatment liquids

| Ingredient | INV-PL2 | INV-PL3 | INV-PL4 |
|---|---|---|---|
| Poval 56 98 | 4.0 | 4.0 | 4.0 |
| Mg(NO₃)2•6H₂O | 10.71 | 10.71 | 10.71 |
| Kauropal K933 | 0.04 | 0.04 | 0.04 |
| Tego Foamex 822 | 0.04 | 0.04 | 0.04 |
| Boric acid | 0.29 | — | — |
| Glyoxal 40 | — | 0.7 | 1.41 |
| D.I. water | To complete | To complete | To complete |
| | to 100% | to 100% | to 100% |
| Viscosity @ | 80 mPas | 56.8 mPas | 63.1 mPas |
| 1000 s⁻¹ | | | |

An aqueous cyan ink was prepared by first making a concentrated aqueous pigment dispersion. The dispersion was made by mixing a composition according to Table 5 for 30 minutes using a Disperlux™ Yellow mixer. Table 5 lists the exact composition of the dispersion.

TABLE 5
Composition of a cyan pigment dispersion

| | Cyan pigment |
|---|---|
| Ingredient | dispersion |
| Cyan Pigment | 15.00 |
| Edaplan | 7.5 |
| Proxel | 0.02 |
| 1,2 Hexanediol | 1.0 |
| D.I. Water | to complete |
| | 100.00 wt % |

An aqueous cyan pigment ink was prepared by mixing the ingredients according to Table 6 expressed in wt. % based on the total weight of the ink.

TABLE 6
Composition of an inventive inkjet ink

| Component | INV-INK2 |
|---|---|
| Cyan Pigment Dispersion | 14.67 |
| Proxel | 0.2 |
| Surfynol 104PG50 | 0.4 |
| Glycerol | 32.0 |
| Ethylene glycol | 15.4 |
| 1.2 Hexanediol | 2.85 |
| D.I. Water | To complete |
| | to 100% |

### B.4.2. Results of Image Quality Evaluation

The pre-treatment liquids INV-PL2 to INV-PL4 were adhered to the coated corrugated liner as described in § B.2.1. by means of a 4 μm spiral bar. The pre-treated samples were printed as described in § B.2.1. and the image quality of the obtained images was evaluated according § B.2.2.

It is clear from the evaluation of the image quality that a better ink spreading is obtained with the boric acid containing pre-treatment liquid than with the glyoxal containing pre-treatment liquid.

1-14. (canceled)

15. A recording method of inkjet printing on an absorbing medium, the method comprising following steps:
a) transporting the absorbing medium in a conveying direction, the medium having a width transversally oriented to the conveying direction;
b) adhering a pre-treatment liquid at least partially over the width of the absorbing medium to form a layer having a thickness from 1 to 5 μm, the pre-treatment liquid comprising water, a fixing agent, a hydrophilic binder selected from the group consisting of polyvinyl alcohol (PVOH) or modified polyvinylalcohol, water dispersible ethylene vinyl alcohol (EVOH), polysaccharides and combinations of two or more thereof, wherein the pre-treatment liquid has a viscosity from 40 to 300 mPa·s at a shear rate of 1000 s⁻¹ at 25° C.;
c) applying an aqueous inkjet ink to the layer to form an image by ejecting the ink from an inkjet head, wherein the ink comprises a pigment and a water-soluble organic solvent; and
d) drying the layer and the applied inkjet ink by applying heat and air flow to the image.

16. The recording method according to claim 15, wherein the absorbing medium is a paper substrate, a corrugated cardboard, or a paper board.

17. The recording method according to claim 15, wherein the pre-treatment liquid further comprises a cross-linking agent.

18. The recording method according to claim 16, wherein the pre-treatment liquid further comprises a cross-linking agent.

19. The recording method according to claim 17, wherein the cross-linking agent is boric acid and the hydrophilic binder is polyvinyl alcohol.

20. The recording method according to claim 18, wherein the cross-linking agent is boric acid and the hydrophilic binder is polyvinyl alcohol.

21. The recording method according to claim 15, wherein the inkjet ink is applied in a time interval from 200 ms to 30 s after the adhering of the pre-treatment liquid.

22. The recording method according to claim 15, wherein the head can be a fixed array of nozzles oriented transversally to the conveying direction or can be scanning in a direction transversally to the conveying direction.

23. The recording method according to claim 15, wherein the amount of hydrophilic binder is from 15 to 45 wt. % with respect to the total amount of dry compounds.

24. The recording method according to claim 15, wherein the water-soluble organic solvent has a boiling point from 150° C. to 250° C. and the amount is 20 wt. % or more with respect to the total weight of the pre-treatment liquid.

25. The recording method according to claim 18, wherein the water-soluble organic solvent has a boiling point from 150° C. to 250° C. and the amount is 20 wt. % or more with respect to the total weight of the pre-treatment liquid.

26. The recording method according to claim 20, wherein the water-soluble organic solvent has a boiling point from 150° C. to 250° C. and the amount is 20 wt. % or more with respect to the total weight of the pre-treatment liquid.

27. The recording method according to claim 15, wherein the adhering is carried out by means of flexographic printing.

28. The recording method according to claim 18, wherein the adhering is carried out by means of flexographic printing.

29. The recording method according to claim 27, wherein the flexographic printing includes the adhering of the pre-treatment liquid to the absorbing medium by means of an anilox roller.

30. The recording method according to claim 15, wherein after step d), a varnish is applied onto the image, wherein the varnish comprises water and a resin.

31. A liquid set comprising a pre-treatment liquid and an aqueous inkjet ink, wherein the aqueous ink comprises a pigment, a wax, and a water soluble organic solvent having a boiling point from 150° C. to 250° C., and the pre-treatment liquid comprises water, a multivalent metal salt, a polyvinyl alcohol, and a cross-linker, and wherein the pre-treatment liquid has a viscosity from 40 to 300 mPa·s at a shear rate of 1000 s⁻¹ at 25° C.

32. The liquid set according to claim 31, wherein the pigment is encapsulated by means of a cross-linked polymeric shell.

33. The liquid set according to claim 32, further comprising a varnish, wherein the varnish comprises water and a resin selected from the group consisting of a polyacrylate, a wax, and a polyurethane.

34. The liquid set according to claim 31, further comprising a varnish, wherein the varnish comprises water and a resin selected from the group consisting of a polyacrylate, a wax, and a polyurethane.
